(19) United States
(12) Patent Application Publication
(10) Pub. No.: US 2018/0272765 A1
(43) Pub. Date: Sep. 27, 2018

(54) PRINTER APPARATUS

(71) Applicant: TOSHIBA TEC KABUSHIKI KAISHA, Tokyo (JP)

(72) Inventor: Jun Iwamoto, Sunto Shizuoka (JP)

(21) Appl. No.: 15/880,637

(22) Filed: Jan. 26, 2018

(30) Foreign Application Priority Data
Mar. 21, 2017 (JP) 2017-054883

(51) Int. Cl. B41J 15/04; B41J 2/32; B41J 3/407; B41J 11/70

(52) U.S. Cl. CPC B41J 15/042; B41J 11/70; B41J 3/4075; B41J 2/32

(57) ABSTRACT

A printer apparatus of a drop-in type includes a storage region for a roll of print sheet, a print head, a conveying roller configured to contact the print sheet and rotate to cause the print sheet to be conveyed from the roll to the print head, and a flap having a distal end that contacts an outer circumferential surface of the roll at a point that is lower than a center of the roll while the print sheet is drawn out from the roll for conveyance to the print head.

### CROSS-REFERENCE TO RELATED APPLICATION

This application is based upon and claims the benefit of priority from Japanese Patent Application No. 2017-054883, filed Mar. 21, 2017, the entire contents of which are incorporated herein by reference.

### FIELD

Embodiments described herein relate generally to a printer apparatus.

### BACKGROUND

A thermal printer is known by which a print sheet is drawn out from a roll formed by winding the print sheet in a roll shape and information is printed on the print sheet. Recently, a label sheet that does not contain a liner is wound in a roll and used as a print sheet. Such a label sheet is stored in a printer in a state in which the label sheet is fixed to a shaft, a core, or the like supported by the printer. The print sheet is drawn out and printing is performed thereon.

With such a conventional method of storing the print sheet, since the shaft or the core for fixing the roll is present, when the print sheet is replaced, it is necessary to manually detach the shaft or the core from the nearly empty roll and thereafter manually attach the shaft or the core to a new roll and load the new roll into the printer. In order to reduce such labor and time during the replacement, there has been proposed a so-called “drop-in” type with which it is possible to replace the roll simply by depositing the roll in a storing section of the printer.

With the label sheet that does not contain a liner, the rear surface of the printing surface is adhesive. Therefore, the label sheet is less easily peeled when being peeled from the roll for printing. That is, when the label sheet is drawn out from the roll, the roll itself receives a pulling force in a drawing-out direction of the label sheet due to the adhesive surface. With the force, it is likely that the roll becomes displaced and moves inside the printer. In addition, when the remaining amount of the label sheet is small, a displacement amount of the roll is large. This is because as the diameter of the roll becomes smaller than the original, and free space around the roll becomes greater. When the roll is displaced inside the storing section, it is likely that position accuracy of the label sheet peeled and drawn out from the roll is deteriorated. It is also likely that vibration and noise are caused by the displacement.

### DESCRIPTION OF THE DRAWINGS

FIG. 1 is a perspective view showing the exterior of a label printer according to an embodiment;

FIG. 2 is a perspective view showing a state in which an upper case of the label printer is opened;

FIG. 3 is a first sectional view showing an internal structure of the label printer;

FIG. 4 is a second sectional view showing the internal structure of the label printer;

FIGS. 5A and 5B are diagrams for explaining the structure of an urging section of a flap; and

FIG. 6 is a diagram for explaining behavior of a roll in a conventional label printer.

### DETAILED DESCRIPTION

Embodiments provide a printer apparatus of a drop-in type in which a roll of a print sheet is stored and in which, even when the print sheet is drawn out from the roll for printing thereon, the roll is not displaced.

In general, according to one embodiment, a printer apparatus includes a storage region for a roll of print sheet, a print head, a conveying roller configured to contact the print sheet and rotate to cause the print sheet to be conveyed from the roll to the print head, and a flap having a distal end that contacts an outer circumferential surface of the roll at a point that is lower than a center of the roll while the print sheet is drawn out from the roll for conveyance to the print head.

A label printer 10 according to an embodiment is explained below with reference to the accompanying drawings. Explanation of the overall configuration of the label printer

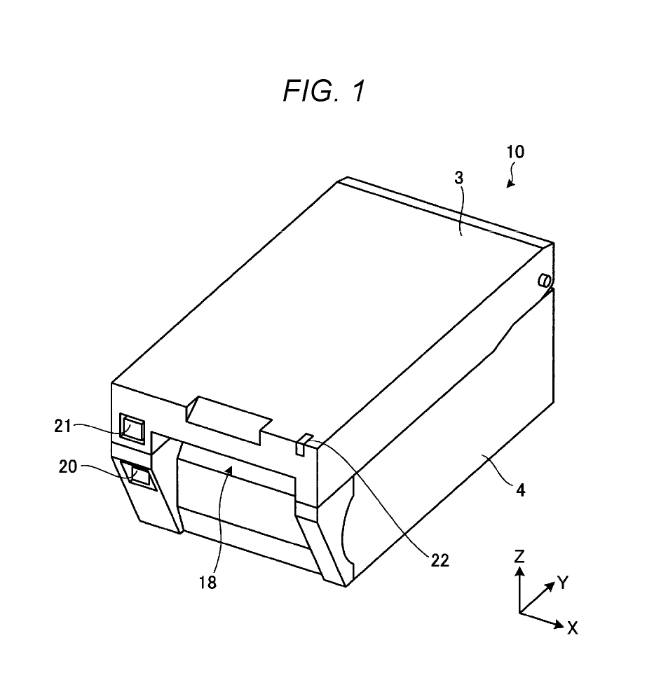

FIG. 1 is a perspective view showing the exterior of the label printer 10, which is an example of a printing apparatus according to this embodiment. The label printer 10 includes an upper case 3, a lower case 4, a discharge port 18, a power switch 20, a feed switch 21, and an indicator 22. As shown in FIG. 1, a direction along the width of the discharge port 18 of the label printer 10 is represented as the X axis, a direction from the discharge port 18 of the label printer 10 to an upstream side is represented as the Y axis, and a direction from the bottom surface to the upper surface of the label printer 10 is represented as the Z axis.

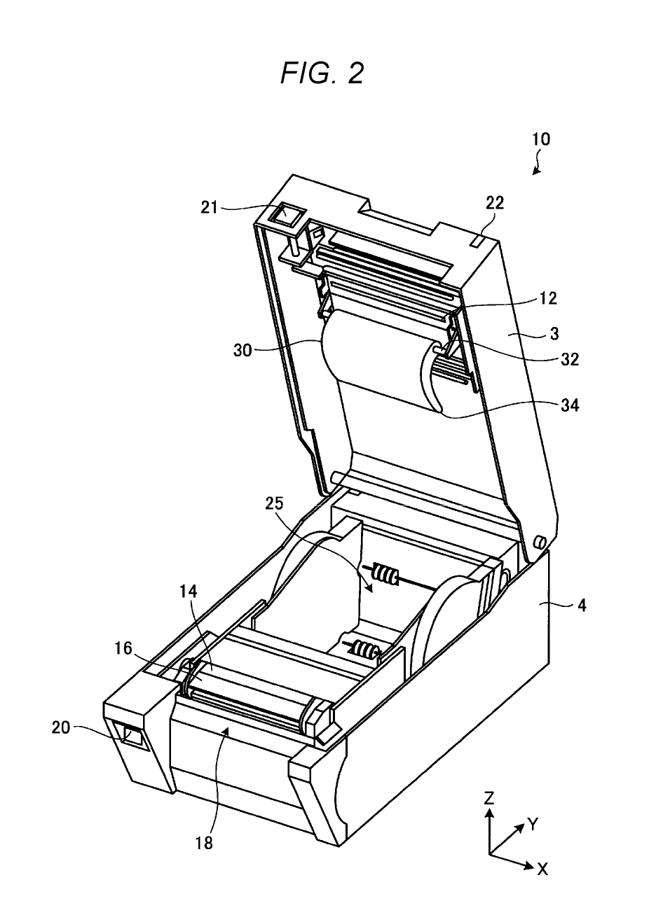

FIG. 2 is a perspective view showing a state in which the upper case 3 of the label printer 10 is opened. The label printer 10 includes a thermal head 12, a platen roller 14, a cutter 16, and a storing section 25 on the inside.

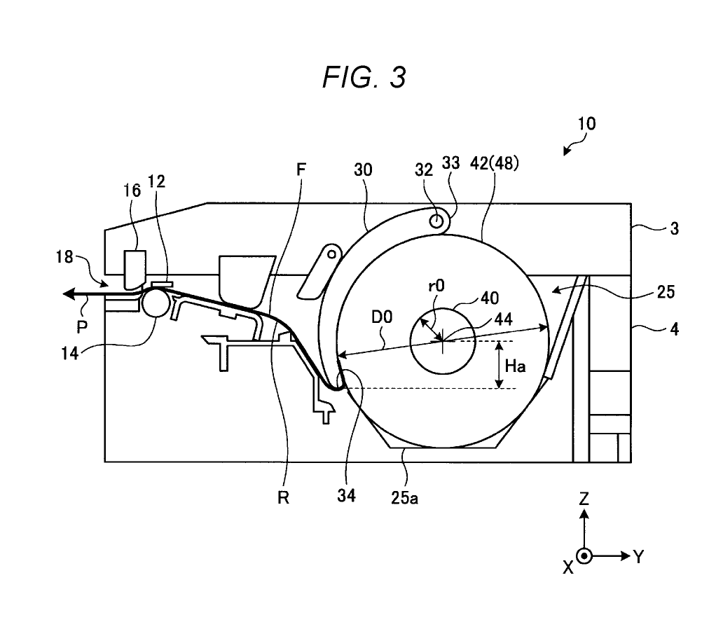

The storing section 25 stores a roll (not shown). The roll is formed by winding heat-sensitive paper, which is a print sheet, in a roll shape. In this embodiment, the print sheet is a label sheet that does not contain a liner (hereinafter simply referred to as label sheet). Therefore, the roll is wound in a state in which the rear adhesive surface of the label sheet contacts a printing surface of the label sheet. When printing is performed on the label sheet, as explained below, one end of the label sheet is pulled by rotation of the platen roller 14 and the label sheet is peeled from the roll (FIG. 3).

The label printer 10 in this embodiment adopts a so-called “drop-in” type for, when storing the roll, as shown in FIG. 2, opening the upper case 3 and depositing the roll in the storing section 25 to store the roll.

The lower case 4 is a rectangular parallelepiped case having an upper surface side which is open. The upper surface side of the lower case 4 is closed by the upper case 3. In the lower case 4, a connection terminal (not shown in the figure) may be provided for connection of the label printer 10 to an external apparatus. For example, a power supply terminal (not shown in the figure) may be provided for supplying electric power to the label printer 10.

An edge on the back side (the positive Y-axis side) of the upper case 3 is hinged to the lower case 4. The upper surface side of the lower case 4 is opened and closed according to the movement of the upper case 3.

The discharge port 18 for discharging the label sheet peeled from the roll and printed, is provided at the front end (negative Y-axis side) of the upper case 3 and the lower case 4 between the lower part of the upper case 3 and the upper part of the lower case 4.

The thermal head 12 is fixed to the inner side surface of the upper case 3. In the closed state, the thermal head contacts the platen roller 14, which is included in the lower case 4. The platen roller 14 rotates according to transmission of a driving force of a stepping motor (not shown). The platen roller 14 conveys the label sheet held between the platen roller 14 and the thermal head 12 from the storing section 25 on the upstream side toward the discharge port 18 on the downstream side.

The power switch 20 turns on and off power supply to the label printer 10. The feed switch 21 conveys the label sheet from the storing section 25 side toward the discharge port 18 side by a predetermined amount . The indicator 22 is, for example, an LED. The indicator 22 is lit or flashed to display a state of the label printer 10 including a power supply state.

A flap 30 is attached to the rear surface side of the upper case 3. The flap 30 extends along the X-axis direction. The flap 30 also extends along an outer circumferential surface of the roll 42 from a terminal end portion 33 (FIG. 3) toward a distal end portion 34, and has a curvature that matches the curvature of the outer circumferential surface of the roll 42. The terminal end portion 33 is axially supported by a shaft section 32 along the X axis, and rotates around the shaft section 32. A function of the flap 30 is explained below. Explanation of a comparative example

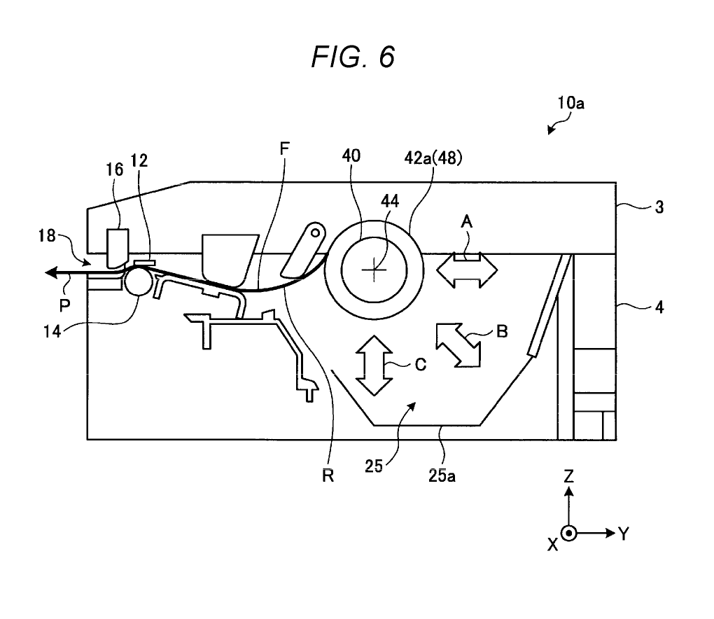

First, as a comparative example of this embodiment, conventional behavior during printing on a roll 42a stored in the storing section 25 is explained with reference to FIG. 6. FIG. 6 is a diagram for explaining behavior of the roll 42a in the conventional label printer 10a. The roll 42a shown in FIG. 6 is in a state in which the original diameter of a roll 42 D0 (FIG. 3) has become a smaller diameter D1. The label sheet 48 is conveyed in the negative Y-axis direction shown in FIG. 3 in a state in which a printing surface F is set on an upper side (the positive Z-axis side) and an adhesive rear surface R is set on a lower side (the negative Z-axis side).

In FIG. 6, the diameter of the roll 42a is smaller than the original. When the label sheet 48 is peeled from the roll 42a and drawn out for printing according to the rotation of the platen roller 14, the roll 42a receives a force in the negative Y-axis direction. In this state, the platen roller 14 is present above (on the positive Z-axis positive) of the roll 42a when the roll 42a is stored on a bottom surface 25a of the storing section 25. Therefore, when the label sheet 48 is drawn out, because of the adhesive rear surface R of the label sheet 48, the roll 42a is pulled up.

FIG. 6 shows a state in which the roll 42a is pulled up in this way. In this state, a force acts on the roll 42a in the negative Y-axis direction along which the platen roller 14 pulls the label sheet 48 and gravity corresponding to the own weight of the roll 42a act on the roll 42a in the negative Z-axis direction. When the roll 42a falls to the bottom surface 25a of the storing section 25 with gravity acting on the roll 42a, a rebound force acts on the roll 42a as a reaction force at the time the roll 42a collides with the bottom surface 25a as a result of the fall. In this way, the roll 42a is displaced in directions of arrow A, arrow B, and arrow C shown in FIG. 6 on the inside of the storing section 25 by a plurality of forces acting on the roll 42a. The magnitude of the displacement of the roll 42a in the direction of the arrows A, B, and C depends on the weight of the roll 42a, the adhesive magnitude of the label sheet 48, and a drawing-out force of the label sheet 48.

When the roll 42a is displaced inside the storing section 25, as explained above, it is likely that the position accuracy of the label sheet 48 is deteriorated and it is likely that vibration and sound occur.

### Explanation of Action of the Flap

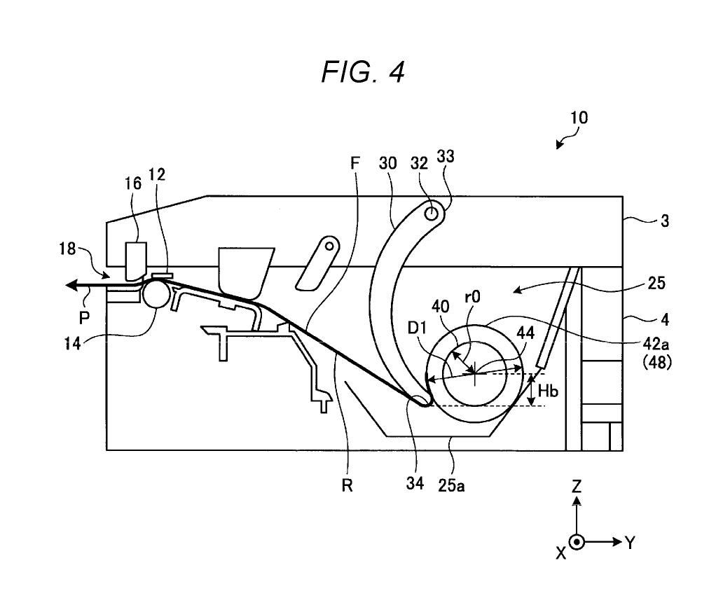

Action of the flap 30 is explained with reference to FIGS. 3 and 4. FIG. 3 is a first sectional view showing an internal structure of the label printer 10 (showing the YZ plane). FIG. 4 is a second sectional view showing the internal structure of the label printer 10 (showing the YZ plane).

FIG. 3 shows the roll 42 formed by winding the label sheet 48 around a roll core 40 having a radius r0, which is stored in the storing section 25 of the label printer 10, in a state in which the label sheet 48 has a sufficient remaining amount (diameter D0). FIG. 4 shows a state in which diameter D1 of the roll 42a, which is smaller than the original diameter, is stored in the storing section 25 of the label printer 10.

In FIG. 3, the label sheet 48 is drawn out from the roll 42 toward the arrow P direction (the negative Y-axis direction) through the distal end portion 34 of the flap 30 while being guided by the distal end portion 34, that is, the label sheet 48 peeled from the roll 42 is drawn out toward the arrow P direction. The distal end portion 34 of the flap 30 has a curved surface shape along the Y-axis direction (i.e., the conveying direction of the label sheet 48). Therefore, the conveying direction of the label sheet 48 that is peeled and drawn out from the roll 42 at the distal end portion 34 of the flap 30, is gradually changed. For that reason, the label sheet 48 is smoothly drawn out and conveyed without cracks or scratches.

As explained above, the drawn-out label sheet 48 is conveyed toward the arrow P direction, that is, toward the discharge port 18, according to the rotation of the platen roller 14. In this state, the label sheet 48 is held between the platen roller 14 and the thermal head 12. The thermal head 12 prints label information on the label sheet 48. The cutter 16 cuts the label sheet 48 after the printing for each of labels.

In FIG. 3, the terminal end portion 33 of the flap 30 is axially supported by the shaft section 32 extending along the X axis . The flap 30 is rotated around the X axis . The surface of the flap 30 is in contact with the outer circumferential surface of the roll 42. As explained in detail below, the flap 30 is urged in the opposite direction of the direction in which the label sheet 48 is drawn out and conveyed, that is, in the positive Y-axis direction toward a winding center 44 of the roll 42 (the center of the roll core 40).

Further, in FIG. 3, the distal end portion 34 of the flap 30 is located further on the Z-axis negative side, that is, closer to the bottom surface 25a side of the storing section 25 than the winding center 44 of the roll 42. As shown in FIG. 3, the distal end portion 34 of the flap 30 is located in a position lower than the winding center 44 of the roll 42 by height Ha. Therefore, in FIG. 3, the label sheet 48 is peeled from the roll 42 and drawn out in the negative Z-axis direction first. Thereafter, the label sheet 48 is guided by the distal end portion 34 of the flap 30 and conveyed in a direction toward the discharge port 18 (in the negative Y-axis direction) through the platen roller 14. That is, while the roll 42 is pressed in the positive Y-axis direction by the flap 30, the label sheet 48, when peeled from the roller 42, is guided by the distal end portion 34 to be drawn out initially in the negative Z-axis direction. After bring drawn out, the label sheet 48 is conveyed in the negative Y-axis direction.

The flap 30 has a curved surface shape, and the curve extends along the outer circumferential surface. With this shape, the distal end portion 34 is in contact with the outer circumferential surface. For that reason, when the label sheet 48 is peeled from the roll 42, a force in the negative Z-axis direction acts on the roll 42. Further, gravity in the negative Z-axis direction corresponding to the weight of the roll 42 acts on the roll 42.

In this way, a force toward the Y-axis negative direction in which the label sheet 48 is pulled by rotating the platen roller 14, gravity acting in the negative Z-axis direction, a pressing force of the flap 30 acting in the positive Y-axis direction, and a force for peeling the label sheet 48 acting in the negative Z-axis direction act on the roll 42. Since these forces act in directions different from one another, displacement of the roll 42 in the negative Y-axis direction is suppressed.

On the other hand, in FIG. 4, the roll 42a with a small remaining amount of the label sheet 48 is pressed in the positive Y-axis direction by the flap 30 in the same manner as explained above. In the case of FIG. 4, as in FIG. 3, the distal end portion 34 is located further on the negative Z-axis side than the winding center 44 of the roll 42 having the radius r0. In this case, the distal end portion 34 of the flap 30 is present in a position lower than the winding center 44 of the roll 42 by height Hb. That is, in FIG. 4, as in FIG. 3, the label sheet 48 is peeled and drawn out in the negative Z-axis direction and thereafter conveyed in the direction toward the discharge port 18 (i.e., the negative Y-axis direction). Therefore, even in the state shown in FIG. 4, the roll 42 is not pulled in the conveying direction accompanying the label sheet 48. That is, the roll 42 is not displaced inside the storing section 25.

In FIG. 4, the roll 42a stays in a position where the roll 42a has been lifted from the bottom surface 25a of the storing section 25. This is because the roll 42a stays in a position where the three forces acting on the roll 42a are balanced when the label sheet 48 is conveyed, where the three forces are the weight of the roll 42a which is applied in the negative Z-axis direction, the force of the flap 30 pressing the roll 42a which is applied toward the positive Y-axis direction, and the force from peeling the label sheet 48 which is applied toward the negative Z-axis direction.

That is, the roll 42a stays in a position corresponding to the weight of the roll 42a determined according to a remaining amount of the label sheet 48, a contact position of the flap 30 with the roll 42a, the pressing force of the flap 30, and a force of the platen roller 14 pulling the label sheet 48.

In FIG. 4, the position of the flap 30 in the Z-axis direction is determined on the basis of a diameter (2r0) of the roll core 40 and the depth of the storing section 25 in the Z-axis direction. That is, the position of the flap 30 in the Z-axis direction is determined such that the distal end portion 34 of the flap 30 pressed against the roll core 40 is located between the winding center 44 of the roll 42 and the bottom surface 25a of the storing section 25 when the roll core 40 having the radius r0 is stored in a deepest part of the storing section 25 (a part closest to the negative Z-axis side in the bottom surface 25a).

### Explanation of Action of the Urging Section of the Flap

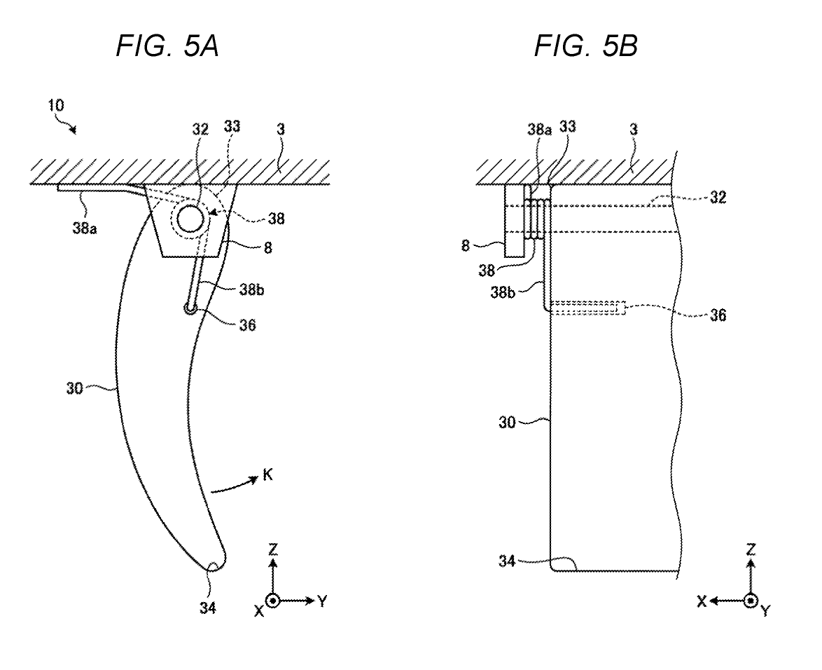

The urging section of the flap 30 is explained with reference to FIGS. 5A and 5B. FIGS. 5A and 5B are diagrams for explaining the structure of the urging section of the flap 30 included in the label printer 10.

FIG. 5A is a diagram of the flap 30 viewed from the X-axis positive side. FIG. 5B is a diagram of the flap 30 viewed from the Y-axis positive side.

As shown in FIG. 5A, the shaft section 32 penetrates through the terminal end portion 33 of the flap 30 in the X-axis direction. Both ends of the shaft section 32 are fixed by a shaft-section fixing member 8 attached to the upper case 3, and the shaft section 32 is provided to allow the flap 30 to rotate around the X axis.

Near an end portion of the shaft portion 32, a torsion spring 38, which is an example of the urging section, is set between the shaft-section fixing member 8 and the flap 30. A movement of one arm 38a of the torsion spring 38 is limited on the rear surface side of the upper case 3. The other arm 38b of the torsion spring 38 is bent, for example, 90° and inserted into a hole section 36 opened in the flap 30 to be locked.

In this state, when the roll 42 is stored in the storing section 25 and the upper case 3 is closed as shown in FIG. 3, the flap 30 receives a force corresponding to (more particularly, proportional to) the diameter D0 (FIG. 3) of the roll 42, from the outer circumferential surface of the roll 42 toward the negative Y-axis direction. The torsion spring 38 receives a deflection force according to the force received by the flap 30. As a reaction to the deflection force, the torsion spring 38 applies a restoring force to the flap 30 in a direction in which deflection is released, that is, in the positive Y-axis direction (indicated by an arrow K in FIG. 5A). The flap 30 urges the roll 42 in the Y-axis positive direction with the restoring force.

The torsion spring 38 may be simultaneously set on the other end side of the shaft section 32. By setting the torsion spring 38 at both the ends of the shaft section 32 in this way, it is possible to more uniformly press the roll 42 (FIG. 3).

As explained above, in the label printer 10 (the printer apparatus) according to this embodiment, the platen roller 14 conveys the label sheet 48 from the roll 42, which is formed by winding the label sheet 48, stored in the storing section 25 toward the thermal head 12, which performs printing, while drawing out one end of the label sheet 48 from the roll 42. When the label sheet 48 is conveyed, the flap 30 comes into contact with the outer circumferential surface of the roll 42 from above the storing section 25 and presses the roll 42 stored in the storing section 25 in the opposite direction (the positive Y-axis direction) of the conveying direction of the label sheet 48 (the negative Y-axis direction). In this state, the distal end portion 34 of the flap 30 is located between the winding center 44 of the roll 42 and the bottom surface 25a of the storing section 25. Therefore, when the label sheet 48 is drawn out from the roll 42, the flap 30 can prevent the roll 42 from being displaced in the Y-axis negative direction.

In the label printer 10, the flap 30 has a curved surface shape extending along the outer circumferential surface of the label sheet 48. Therefore, it is possible to dispose the distal end portion 34, which is the guide section, in a position close to the outer circumferential surface of the label sheet 48. For that reason, when the label sheet 48 is peeled and drawn out from the roll 42, it is possible to cause a force toward the negative Z-axis direction to act on the roll 42. Consequently, it is possible to prevent the roll 42 from being displaced in the Y-axis negative direction.

In the label printer 10, the distal end portion 34 of the flap 30 has the curved surface shape over the conveying direction of the label sheet 48 from the position in contact with the outer circumferential surface of the label sheet 48. Therefore, it is possible to convey the label sheet 48 peeled from the roll 42 while smoothly changing the direction of the label sheet 48 without causing cracks or scratches.

In the label printer 10, the terminal end portion 33 of the flap 30 is set to allow the flap 30 to rotate around the X axis above the storing section 25. Therefore, the flap 30 can firmly press the roll 42.

The label printer 10 further includes the torsion spring 38 that urges the flap 30 toward the opposite direction of the conveying direction of the label sheet 48. Therefore, the flap 30 can press the roll 42 more firmly. For that reason, it is possible to prevent the roll 42 from being displaced inside the storing section 25.

In the label printer 10, the label sheet 48 that does not contain a liner is used as the print sheet. Therefore, it is possible to perform printing on the label sheet 48 without causing liner dust after the printing. By adopting this mechanism, even if a printing medium in use is not the label sheet 48, which has an adhesive on the rear surface R, but a roll formed by winding heat-sensitive paper not having adhesion on the rear surface R, it is still possible to prevent the roll from being displaced inside the storing section 25. That is, this embodiment can be applied without depending on presence or absence of an adhesive provided on the rear surface of a printing medium wound in a roll.

The embodiment is explained above. However, the embodiment is presented as an example and is not intended to limit the scope of the invention. The new embodiment can be implemented in other various forms. Various omissions, replacements, and changes of the embodiment can be performed without departing from the spirit of the invention. The embodiment and modifications of the embodiment are included in the scope and the gist of the invention and included in the inventions described in claims and the scope of equivalents of the inventions.

What is claimed is:

1. A printer apparatus of a drop-in type, comprising:
a storage region for a roll of print sheet;
a print head;
a conveying roller configured to contact the print sheet and rotate to cause the print sheet to be conveyed from the roll to the print head; and
a flap having a distal end that contacts an outer circumferential surface of the roll at a point that is lower than a center of the roll while the print sheet is drawn out from the roll for conveyance to the print head.

2. The apparatus according to claim 1, wherein the distal end presses the roll in a direction opposite to a conveying direction of the print sheet.

3. The apparatus according to claim 2, wherein the flap is hinged at an end opposite to the distal end.

4. The apparatus according to claim 3, wherein the flap includes a spring that urges the distal end to be pressed against the roll in the direction opposite to a conveying direction of the print sheet.

5. The apparatus according to claim 4, wherein the spring is a torsion spring installed at the hinged end of the flap.

6. The apparatus according to claim 1, wherein the flap has curved planar surface having a curvature that generally conforms to a curvature of an outer circumferential surface of the roll.

7. The apparatus according to claim 1, wherein the distal end in contact with the roll has a curved surface, around which the print sheet is conveyed.

8. The apparatus according to claim 1, wherein the print sheet is a label sheet that does not contain a liner.

9. The apparatus according to claim 1, wherein the conveying roller is positioned to face the print head and the print sheet is conveyed between the print head and the conveying roller.

10. The apparatus according to claim 9, further comprising:
a discharge port; and
a cutter between the discharge port and the print head.

11. A method of conveying a print sheet from a roll to a print head in a printer apparatus of a drop-in type, said method comprising:
rotating a conveying roller while the conveying roller is in contact with the print sheet to cause the print sheet to be conveyed from the roll to the print head; and
pressing an outer circumferential surface of the roll at a point that is lower than a center of the roll while the print sheet is drawn out from the roll with a distal end of a flap.

12. The method according to claim 11, wherein the distal end presses the roll in a direction opposite to a conveying direction of the print sheet.

13. The method according to claim 12, wherein the flap is hinged at an end opposite to the distal end.

14. The method according to claim 13, wherein the flap includes a spring that urges the distal end to be pressed against the roll in the direction opposite to a conveying direction of the print sheet.

15. The method according to claim 14, wherein the spring is a torsion spring installed at the hinged end of the flap.

16. The method according to claim 11, wherein the flap has curved planar surface having a curvature that generally conforms to a curvature of an outer circumferential surface of the roll.

17. The method according to claim 11, wherein the distal end in contact with the roll has a curved surface, around which the print sheet is conveyed.

18. The method according to claim 11, wherein the print sheet is a label sheet that does not contain a liner.

19. The apparatus according toclaim 11, whereintheconveying roller is positioned to face the print head and the print sheet is conveyed between the print head and the conveying roller.

20. The apparatus according to claim 19, further comprising:
printing on the print sheet;
conveying the print sheet so that a printed portion of the print sheet is conveyed downstream of a cutter; and
cutting the print sheet with the cutter after the printed portion of the print sheet has been conveyed downstream of the cutter.
